(19) United States
(12) Patent Application Publication
(10) Pub. No.: US 2007/0175700 A1
(43) Pub. Date: Aug. 2, 2007

(54) T-Post Stepping Aid

(76) Inventor: Dean Moeller, Electra, TX (US)

Correspondence Address: National IP Rights Center, LLC, Suite 400, 550 Township Line Road, Blue Bell, PA, 19422, US

(21) Appl. No.: 11/533,781

(22) Filed: Sep. 21, 2006

Related U.S. Application Data
(60) Provisional application No. 60/764,040, filed on Jan. 31, 2006.

(51) Int. Cl. E06C 9/00

(52) U.S. Cl. 182/92

(57) ABSTRACT

A T-post stepping aid is disclosed. The T-post stepping aid includes a longitudinally extending main stepping body, having a recess extending into the sidewall of the main stepping body for receiving a T-post, and a retaining latch removeably attached to the main stepping body for attaching the main stepping body to said T-post. A method for traversing a T-post fence, such as a barbed wire fence, is additionally disclosed. The main stepping body is initially attached onto a T-post, matching the recess indentation with the T-posts form. The T-post stepping aid is then secured with the retaining latch. Finally the main stepping body is used as a step to traverse the fence and is then removed.

### CROSS REFERENCE TO RELATED APPLICATION

This application claims benefit to provisional application 60/764,040, filed on Jan. 31, 2006, entitled “T-Post Stepping Pad”, which is incorporated herein in its entirety.

### FIELD OF THE INVENTION

The present invention relates toward the field of detachable supporting steps, and in particular to a removable and portable step that assists a user in climbing over any fence utilizing T-posts as a support.

### BACKGROUND OF THE INVENTION

Framers, ranchers, hunters, and law enforcement individuals often find the need to cross over dangerous barbed wire, chained link, and electric fences. The flexibility of these fences and the barbed, chain linked, and wire fencing, makes them extremely dangerous to climb. Therefore, a large amount of prior art has been dedicated to stepping members that can be attached to the T-post portion of these fences, making it much easier to climb over the fence.

U.S. Pat. No. 5,857,542 discloses a step member for being removably secured to a fence post to facilitate a person climbing over a fence. The step member includes a generally integral structure having a protruding lug, including a lug recess. The integral structure of the step member further includes a structural recess, wherein a portion of a fence post may removably lodge. The fence post includes a wire stop for being removably lodged within the lug recess. Instead of a generally integral structure, the step member may include a generally hollow step body, wherein a step extender slidably lodges. A catch or latch member is secured to the hollow body for positioning the step extender in an affixed relationship with respect to the hollow body. A method for climbing over a fence, including removably securing a step member to a wire stop of a fence post, such that the step member may receive the foot of a person who wishes to climb over a fence is disclosed.

U.S. Pat. No. 6,247,553 discloses a step assembly comprising a pair of interengagable steps for use in climbing over a fence having T-shaped posts comprising a first step and a second step; the first step engaging the outer surface of the flat cross bar of the T-shaped post and the second step engaging the perpendicular leg of the T-shaped post, wherein the first step is initially separate from the second step and is releasingly engageable thereto.

U.S. Pat. No. 6,394,228 discloses an accessory for a T-post, having a longitudinal axis, comprising a first bar having a central portion and a longitudinal axis; a second bar having a central portion and a longitudinal axis; and a connecting mechanism for fixedly, but removably connecting the first and second bars together in a secure and fixed relationship to the T-post. The central portions of the first and second bars are adapted to be received around the T-post such that the longitudinal axes of the bars are substantially parallel to one another but substantially perpendicular to the longitudinal axis of the T-post.

U.S. Pat. No. 5,244,058 discloses a portable step that has a tread member that is is pivoted corresponding ends of a pair of support arms that terminate at their opposite ends in projections, which extend from the arms at an acute angle thereto. The support arms are rockable to positions in which they are substantially parallel one another and extend in the same direction from the tread member, thereby enabling the projections to be passed through openings in a fence or other barrier to suspend the tread member in a substantially horizontal position at an intermediate level between the top and bottom of the fence, thereby facilitating scaling of the fence by a person.

There is a need however, for a removable and portable T-post step that can be more safely and securely latched onto a T-post, while maintaining the ease of use taught in the prior art.

### OBJECTS AND SUMMARY OF THE INVENTION

It is an object of the present invention to provide a safe and secure means to traverse a T-post fence.

It is a further object of the present invention to provide a device that can be easily attached and detached from a T-post.

It is a yet further object of the present invention to provide a method for using a T-post stepping aid to traverse a T-post fence.

In accordance, the present invention is a T-post stepping aid comprising a main stepping body, having a first end, second end, first sidewall, second sidewall, topside, and bottomside, as well as a recess extending into the first sidewall of said main stepping body for receiving said T-post; and a retaining latch removeably attached to said main stepping body for retaining said main stepping body to said T-post.

In a second embodiment, the invention is a T-post stepping aid, comprising a main stepping body, having a first end, second end, first sidewall, second sidewall, topside, and bottomside, as well as a recess extending into the first sidewall of said main stepping body for receiving said T-post and a retaining latch removeably attached to the main stepping body for retaining the main stepping body to the T-post.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a perspective view of a T-post stepping aid in accordance with the present invention.

FIG. 2 is a cross perspective view of they T-post stepping aid.

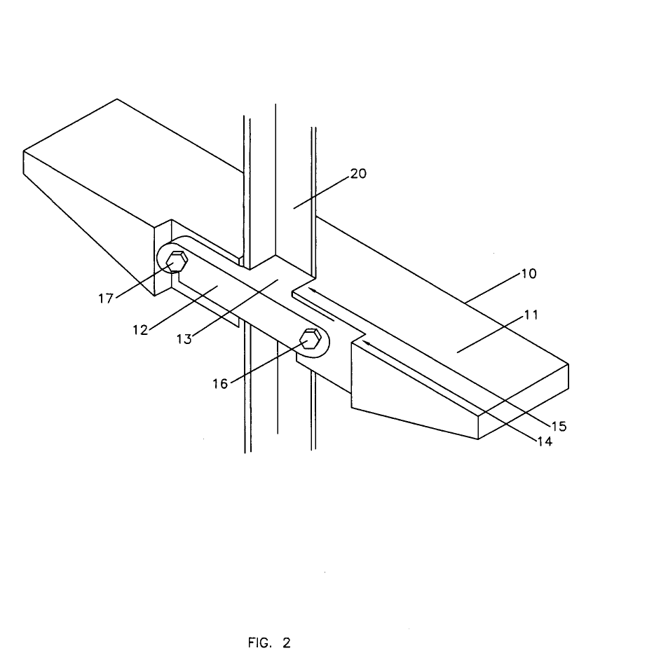

### DETAILED DESCRIPTION OF THE INVENTION

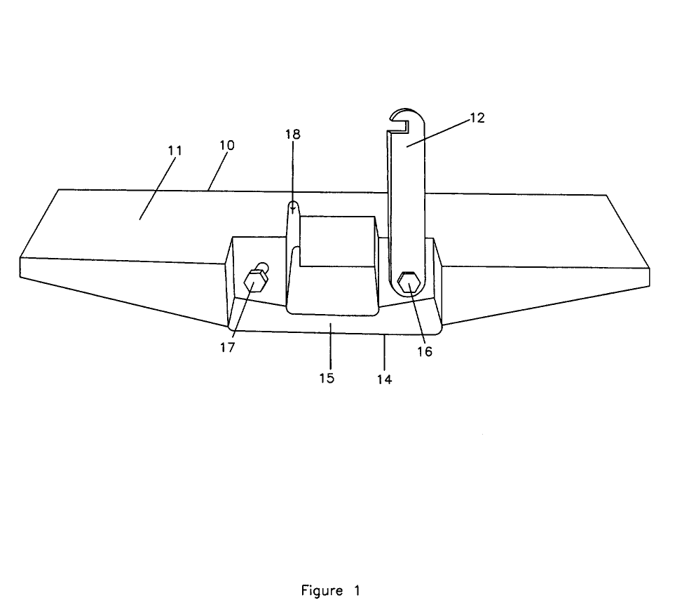

Referring now to the drawings, wherein like reference numerals will refer to the same components across the several views. FIG. 1 shows a T-post stepping aid 10. The T-post stepping aid 10 includes a main stepping body 11, a retaining latch 12, a latch retaining pin 16, and a latch catching pin 17.

The main stepping body 11 includes a first end, a second end, a first a sidewall, a second sidewall, a topside, and a bottomside. In the preferred embodiment, the main stepping body 11 further includes a first recess 14 extending into the first sidewall with a depth to accept the thickness of the retaining latch 12, a width to accept the length of the retaining latch 12, and a height extending from the main stepping body's 11 topside to its bottomside.

In the preferred embodiment, the main stepping body 11 further includes a second recess 15 extending into the first recess 14 with a depth to accept half of the T-post's 20 base length, a width to accept the length of the T-post's 20 center tab length, and a height extending from the main stepping body's 11 topside to its bottomside. The preferred embodiment yet further includes a third recess 18 extending into the second recess 15 with a depth to accept the second half of the T-post's 20 base length, a width to accept the thickness of the T-post's 20 base width, and a height extending from the main stepping body's topside to the bottomside.

The T-post stepping aid's 10 retaining latch 12 includes a longitudinally extending member, having a mounting hole at one longitudinal end to accept the latch retaining pin 16, and a slot at the other longitudinal end, to accept the latch catching pin 17. The latch retaining pin 16 and the latch catching pin 17 are mounted within the first recess 14, on opposite sides of the second recess 15. In a preferred embodiment, the latch retaining pin 16 and latch catching pin 17 are bolts, which screw into threaded holes within the main stepping body 11. In an alternated embodiment, the latch retaining pin 16 and latch catching pin 17 could be clips, magnets, hinges, or simply integrated into the main stepping body 11.

The retaining latch 12 further includes a retention tab 13 extending perpendicularly from the retaining latch's 12 surface and situated within the second recess 15, when the retaining latch is secured in place, adding an additional means to secure the T-post stepping aid 10 to the T-post 20.

In a preferred embodiment, the main stepping body 11, retaining latch 12, latch retaining pin 16, and latch catching pin 17 would be constructed for aluminum. In alternate embodiments, the components could be constructed from metal, plastic, wood, composites, or any other applicable material known to an expert versed in the prior art. In the preferred embodiment, the topside of the main stepping body 11 would contain a gripping surface either integrated into the main stepping body 11 or attached to its topside surface.

The T-post stepping aid 10 is used by first attaching the main stepping body 11 onto a T-post 20, matching the main stepping body's 11 first recess 14, second recess 15, and third recess 18 indentation with the T-post's 20 form. The main stepping body 11 is then secured to the T-post 20 by lowering the retaining latch 12 onto the latch retaining pin 16. A user then uses the topside of the main stepping body 11 as a step to traverse over the T-post 20. Finally, the user then removes the T-post stepping aid 10 from the T-post 20.

While the preferred embodiments of the present invention have been described and illustrated, modifications may be made by one of ordinary skill in the art without departing from the scope and spirit of the invention as defined in the appended claims.

1. A T-post stepping aid, comprising:
a main stepping body, having a first end, a second end, a first sidewall, a second sidewall, a topside, and a bottomside, as well as a recess extending into the first sidewall of said main stepping body for receiving said T-post; and
a retaining latch removeably attached to the main stepping body for retaining the main stepping body to the T-post.

2. The T-post stepping aid of claim 1, wherein the main stepping body's recess further comprises a first recess extending into the first sidewall with a depth to accept the thickness of said retaining latch, a width to accept the length of said retaining latch, and a height extending from said main stepping body's topside to said bottomside.

3. The T-post stepping aid of claim 2, wherein said main stepping body's recess further comprises a second recess extending into said first recess with a depth to accept half of said T-post's base length, a width to accept the length of a T-post's center tab length, and a height extending from said main stepping body's topside to said bottomside.

4. The T-post stepping aid of claim 3, wherein said main stepping body's recess further comprises a third recess extending into said second recess with a depth to accept the second half of said T-post's base length, a width to accept the thickness of said T-post's base width, and a height extending from said main stepping body's topside to said bottomside.

5. The T-post stepping aid of claim 4, wherein said main stepping body's recess further includes a latch securing pin mounted within said first recess to pivotably secure said retaining latch and a latch catching pin mounted within said first recess to catch said retaining latch to secure said T-post stepping aid on said T-post.

6. The T-post stepping aid of claim 5, wherein said retaining latch further includes a retention tab, extending perpendicularly from said retaining latch's surface and situated within said second recess when said retaining latch is secured in place, adding an additional means to secure said T-post stepping aid to said T-post.

7. The T-post stepping aid of claim 6, where said main stepping body has gripping treads on its topside.

8. The T-post stepping aid of claim 7, where said main stepping body, retaining latch, latch retaining pin, and latch catching pin are constructed from materials chosen from a list including metal, plastic, wood, and composites.

9. A T-post stepping aid, comprising:
an aluminum main stepping body, having a first end, a second end, a first sidewall, a second sidewall, a tread gripping topside, and a bottomside;
an aluminum retaining latch having a first end and a second end, said first end having a central hole and said second end having a notch;
a first recess extending into the first sidewall with a depth to accept the thickness of said retaining latch, a width to accept the length of said retaining latch, and a height extending from said main stepping body's topside to said bottomside;
a second recess extending into said first recess with a depth to accept half of said T-post's base length, a width to accept the length of a T-post's center tab length, and a height extending from said main stepping body's topside to said bottomside;
a third recess extending into said second recess with a depth to accept the second half of said T-post's base length, a width to accept the thickness of said T-post's base width, and a height extending from said main stepping body's topside to said bottomside
an aluminum latch securing pin mounted within said first recess to pivotably secure said retaining latch's central hole to secure said retaining latch on said T-post; and
an aluminum latch catching pin mounted within said first recess to catch said retaining latch's notch to secure the T-post stepping aid on the T-post.

10. A method for traversing a T-post fence, comprising:
attaching said main stepping body onto a T-post, matching the main stepping body's recess indentation with the T-posts form;
securing said T-post stepping aid to said T-post by lowering said retaining latch onto said latch retaining pin;
using said topside of said main stepping body to traverse over said T-post; and
removing said T-post stepping aid from said T-post.
